(19) United States
(12) Patent Application Publication
(10) Pub. No.: US 2015/0281427 A1
(43) Pub. Date: Oct. 1, 2015

(54) Internet-Enabled Standby Energy Management System

(71) Applicants: James Onstad, Bend, OR (US); Katie Onstad, Bend, OR (US)

(72) Inventors: James Onstad, Bend, OR (US); Katie Onstad, Bend, OR (US)

(21) Appl. No.: 14/673,717

(22) Filed: Mar. 30, 2015

Related U.S. Application Data
(60) Provisional application No. 61/971,962, filed on Mar. 28, 2014.

(51) Int. Cl. H04M 1/725; H04L 12/28

(52) U.S. Cl. CPC H04M 1/72533; H04L 12/2827; H04L 2012/2841; H04L 2012/2843

(57) ABSTRACT

A smart power outlet and/or power strip can be comprised of any number of active receptacles and deliver any voltage/power rating. The power outlet and power strip relays standby power loss data to a base station via power line communication or another means of wired or wireless communication that minimizes the cost of electrical components. The base station connects to a local area network as a means to communicate power loss data to mobile electronic devices, such as smartphones, and also connects to a Software as a Service (SaaS) based web application. The base station allows a user to access the standby power loss data from a mobile application or an Internet-based SaaS application, to monitor and control energy usage and standby power loss. The base station also allows the user to receive recommended management steps to minimize standby power loss in a home or business.

### CROSS-REFERENCE TO RELATED APPLICATIONS

This application claims the benefit of U.S. Provisional Application No. 61/971,962, filed Mar. 28, 2015.

### STATEMENT REGARDING FEDERALLY SPONSORED RESEARCH OR DEVELOPMENT

Not Applicable PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to energy conservation and monitoring devices, and in particular to an Internet-enabled energy management system. The phenomenon of power leakage, or standby power loss, costs homeowners and businesses a substantial amount of money every year. Conservation-minded people may wonder how much power is being lost from individual power receptacles in their wall outlets, or from their power strips, and seek to control the loss. An Internet-enabled standby energy management system, which enables users to monitor and control standby power loss with their mobile electronic devices, would resolve this problem.

### SUMMARY OF THE INVENTION

Accordingly, the invention is directed to an Internet-enabled standby energy management system. The energy management system comprises a Smart Standby Power Outlet (“power outlet”) and/or a Smart Standby Power Strip, (“power strip”), and a Smart Standby Power Base Station (“base station”). The power outlet and power strip can be comprised of any number of active receptacles, deliver any voltage/power rating, and be of any physical configuration available on the market today. The power outlet and/or power strip relays standby power loss data to the base station via power line communication or another means of wired or wireless communication that minimizes the cost of electrical components. The base station connects to a local area network (LAN) as a means to communicate power loss data to mobile electronic devices, such as smartphones, and also connects to a Software as a Service (SaaS) based web application. The base station allows a user to access the standby power loss data from a mobile application or an Internet-based SaaS application, to monitor and control energy usage and standby power loss. The base station also allows the user to receive recommended management steps to minimize standby power loss in a home or business.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a flowchart displaying the primary base station system operations.

FIG. 2 is a flowchart displaying the process of initializing A/C device connection.

FIG. 3 is a flowchart displaying the process of establishing baseline power levels for devices plugged into receptacles.

FIG. 4 is a flowchart displaying the process of creating energy conservation recommendations.

FIG. 5 is a flowchart displaying the process of applying and maintaining recommendations for receptacles.

FIG. 6 is a flowchart displaying the process of applying and maintaining schedules for receptacles.

FIG. 7 is a flowchart displaying the process of initializing A/C device disconnection.

FIG. 8 is a flowchart displaying the process of installing the Smart Standby Power System.

FIG. 9 is a flowchart displaying the electronic system components, features, communications, and their interconnections, and other relevant processes and events during the course of using the invention.

FIG. 10 is a front view of a mobile electronic device with the mobile application of the first exemplary embodiment installed, displaying the selected power outlet display 10, the cumulative savings display 11, the home icon 12, the outlets icon 13, the schedule icon 14, the manager icon 15, the mobile electronic device 16, the power strip 17, and the receptacle 18.

### DETAILED DESCRIPTION OF THE INVENTION

Referring now to the invention in more detail, the invention is directed to an Internet-enabled standby energy management system. The energy management system comprises a Smart Standby Power Outlet (“power outlet”) and/or Smart Standby Power Strip 17 (“power strip”), and a Smart Standby Power Base Station (“base station”). The power outlet and/or power strip 17 can be comprised of any number of active receptacles 18, deliver any voltage/power rating, and be of any physical configuration available on the market today. Generically, the power outlet or power strip may be understood as receptacle node. The power outlet and/or power strip, relays standby power loss data from each individual receptacle to the base station via power line communication or some other means of wired or wireless communication that minimizes the cost of electronic components. The base station connects to a local area network (LAN) as a means to communicate standby power loss data to mobile electronic devices, such as smartphones, and also connects to a Software as a Service (SaaS) based web application. The base station allows a user to access the standby power loss data from a mobile application or an Internet-based SaaS application, to monitor and control standby power usage and standby power loss. Generically, a mobile application, Saas Application, or other user device or interface is understood as a user interface, which is in electronic communication with the base station via a LAN, the Internet, mobile data network, or other means. The base station also allows the user to receive recommended management steps to minimize energy loss in a home or business.

The first exemplary embodiment provides a Smart Standby Power Base Station (“base station”), one or more Smart Standby Power Outlets (“power outlets”) or Smart Standby Power Strips (“power strips”). Each individual receptacle in the power outlet or power strip provides an internal ammeter to measure standby power usage and standby power loss. The power outlets transmit data to the base station via power line data transmission or another means of wired or wireless communication technology that minimizes the cost of electronic components. Each individual receptacle further provides an electronically controlled relay by which the system may selectively enable and disable power to the particular receptacle.

The base station preferably connects to a local area network (LAN), but may instead connect to a wireless router and modem, to transmit standby power usage and standby power loss data to the user's smartphone, laptop, tablet, or other mobile electronic device 16, and receive input and commands from the user's mobile electronic device 16. A mobile application may be installed on the mobile electronic device 16, or an Internet-based Software as a Service (SaaS) application may be used to monitor and control standby power usage and standby power loss through the power outlets and power strips. The mobile device application operated by the user or an Internet website, operated by the system's managing entity, transmits recommended management steps to the mobile electronic device 16 to minimize power loss and conserve power usage. Recommended management steps can also be generated automatically by the base station.

The home screen display of the mobile application or SaaS application provides a selected power outlet or power strip display 10 and a cumulative savings display 11. Beneath the two displays are four icons: the home icon 12, the outlets icon 13, the schedule icon 14, and the manager icon 15.

The home icon 12 returns the user to the home screen. The outlets function is accessed by clicking on the outlets icon 13. Power outlets and power strips may be reviewed and selected for display and calculation of standby power loss and cumulative savings, in the power outlet display 10 and the cumulative savings display 11. The schedule icon 14 enables the user to access, review, and edit a schedule of activations and shut-offs of the power outlets and power strips to aid in the energy conservation process. The manager icon 15 enables the user to identify appliances, lamps, space heaters, home entertainment electronics, and other devices which are connected to the power outlets and power strips, and compares their standby power usage with other devices in the home or business that are connected to the system.

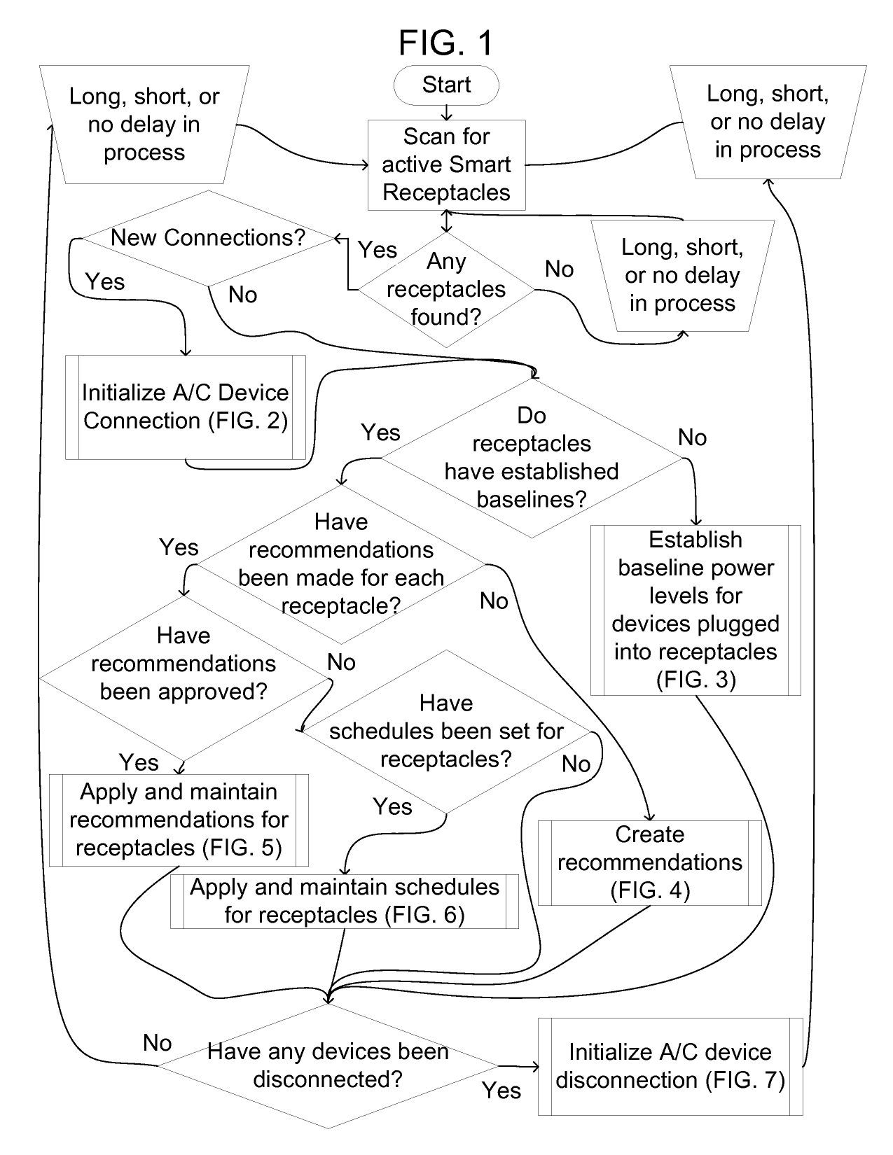

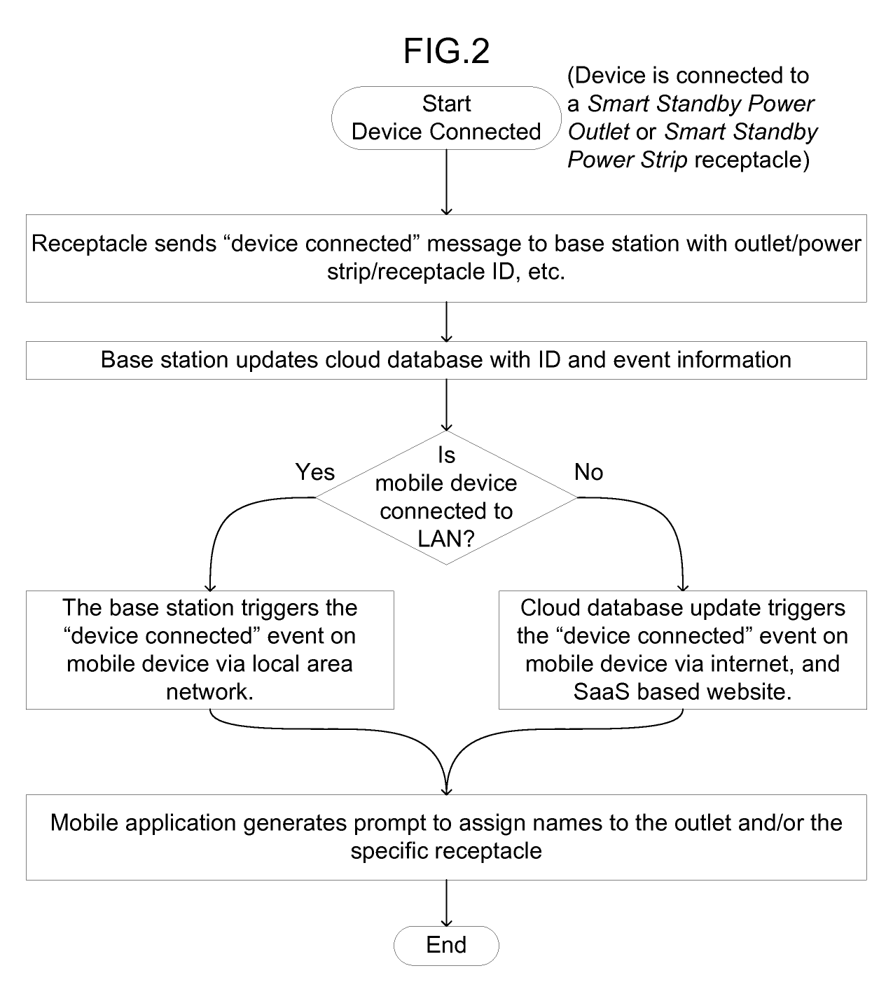

As shown in FIG. 1, they system operates by first scanning for active Smart Receptacles. If no receptacles are found the system continues to scan until one or more are found. Once a receptacle is found, the system determines if the receptacle is a new connection. If the receptacle is a new connection the system initializes A/C device connection as shown in FIG. 2. The receptacle will send a “device connected” message to the base station with the outlet/power strip/receptacle identification information. The base station then updates the cloud database with the identification and event information. A “device connected” event is then sent to and displayed on the mobile device 16 and the internet-based SaaS application. The system will then prompt the user to assign a name to the outlet or specific receptacles.

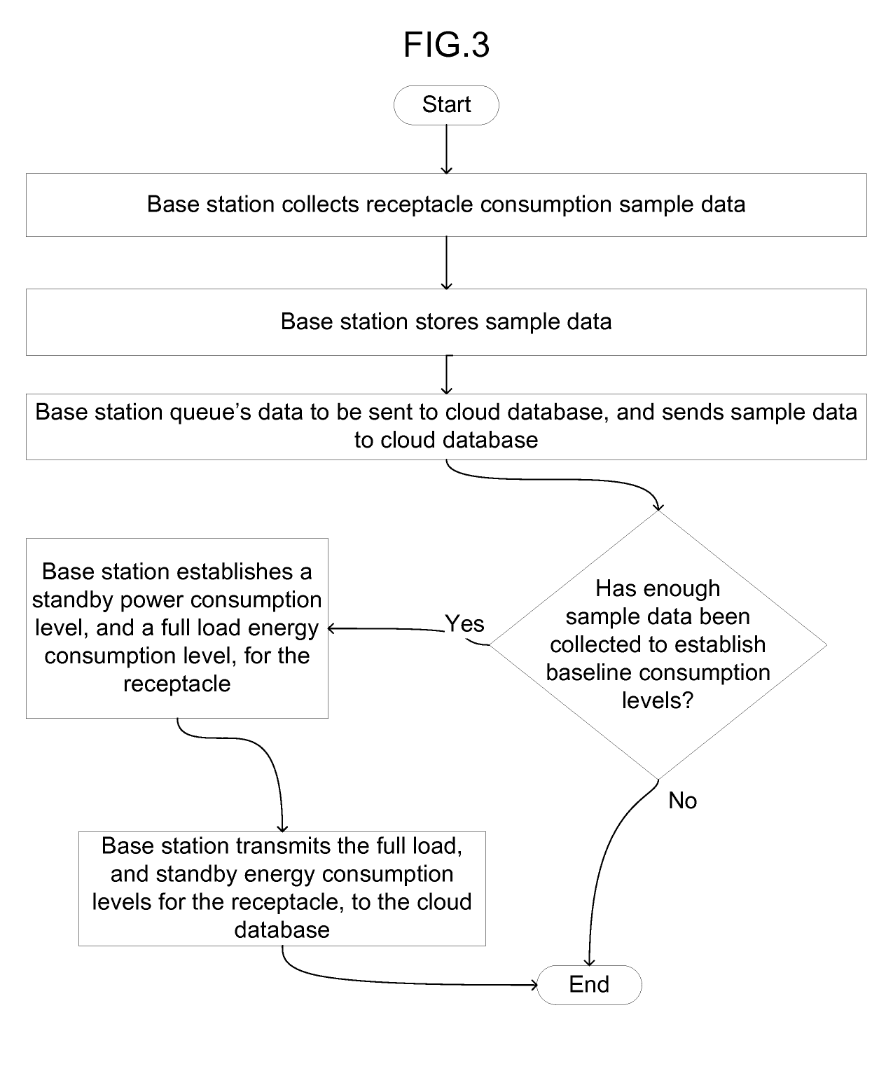

As shown in FIG. 1, the system will then check if the device has an established baseline. If no baseline has been established the system will establish baseline power levels for new devices plugged into receptacles as shown in FIG. 3. The base station will collect consumption data from the device and store it on its own memory device before sending the data to the cloud database. The base station will continue to collect data until a sufficient amount has been collected to establish a baseline. Once enough data has been collected the base station will establish a standby power consumption level as well as a full load power consumption level. These levels are then transmitted to the cloud database for storage.

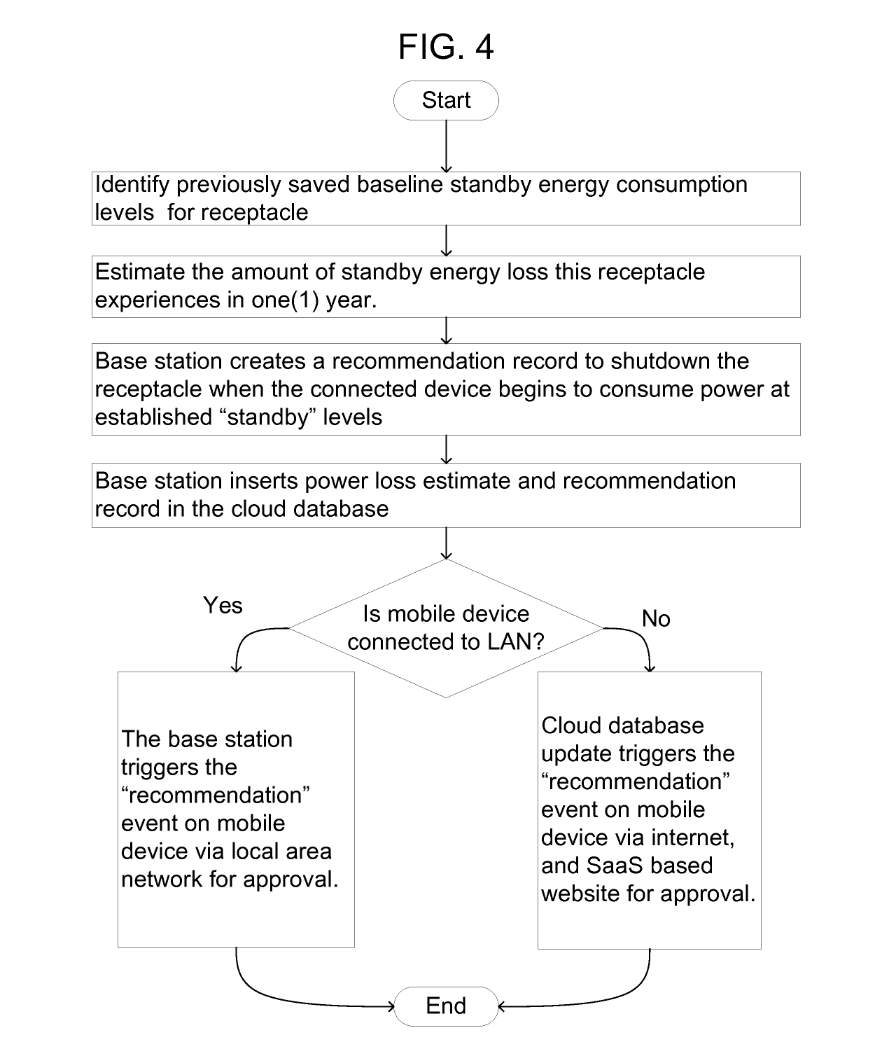

As shown in FIG. 1, the base station will then check if recommendations have been made for each receptacle. If no recommendations have been made for a receptacle, recommendations are created as shown in FIG. 4. The system identifies previously saved baseline standby energy consumption levels for the receptacle and estimates the standby energy loss for the receptacle for one year. The base station then creates a recommendation record to shut down the receptacle when the connected device begins to consume power at the established standby levels. The recommendation and one year standby power loss estimates are uploaded to the cloud database. A recommendation event is then sent to the mobile device and internet-based SaaS application to notify the user.

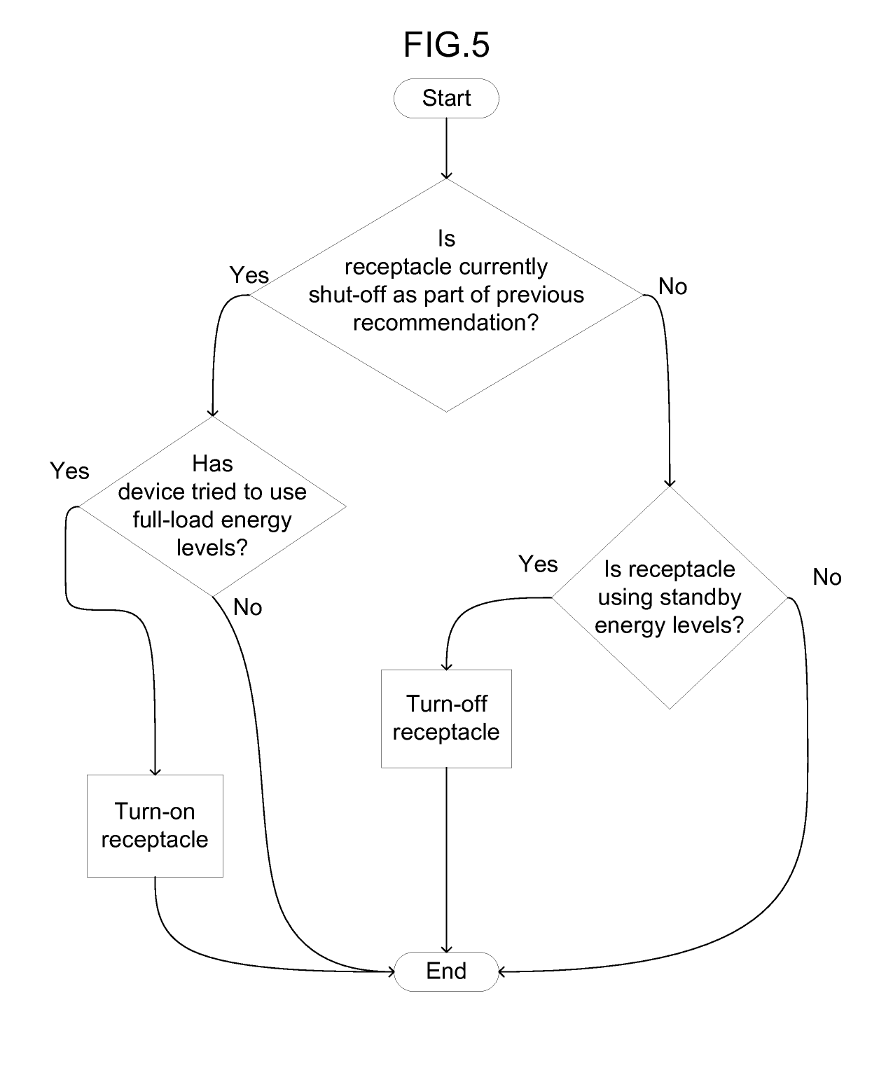

As shown in FIG. 1, the base station will then check if any recommendations have been approved by the user. If recommendations have been approved they are applied and maintained as shown in FIG. 5. The system will check if the receptacle is already shut off as part of a previous recommendation. If the receptacle is shut off the system checks if any devices have attempted to use full load energy levels. If they have, the receptacle is turned on. If they have not attempted to use full load energy levels, the receptacle will remain off. If the receptacle is turned on, the system checks if any devices are using standby energy levels. If a device is using standby energy levels, the receptacle is turned off. If a device is using full load energy levels, the receptacle will remain turned on.

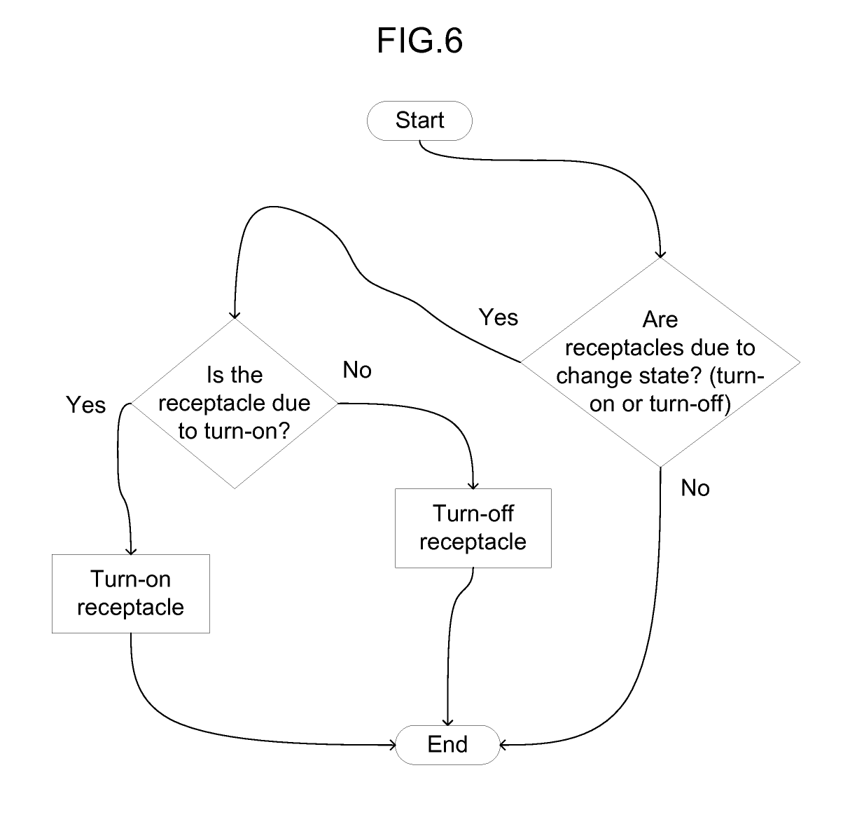

As shown in FIG. 1, the base station will then check if any schedules have been set for receptacles. If schedules have been set, they are applied and maintained as shown in FIG. 6. The system will check if any receptacles are due to change state from either turned on to turned off or vice versa. If the receptacle is due to turn on, the receptacle will turn on. If the receptacle is due to turn off, the receptacle will turn off.

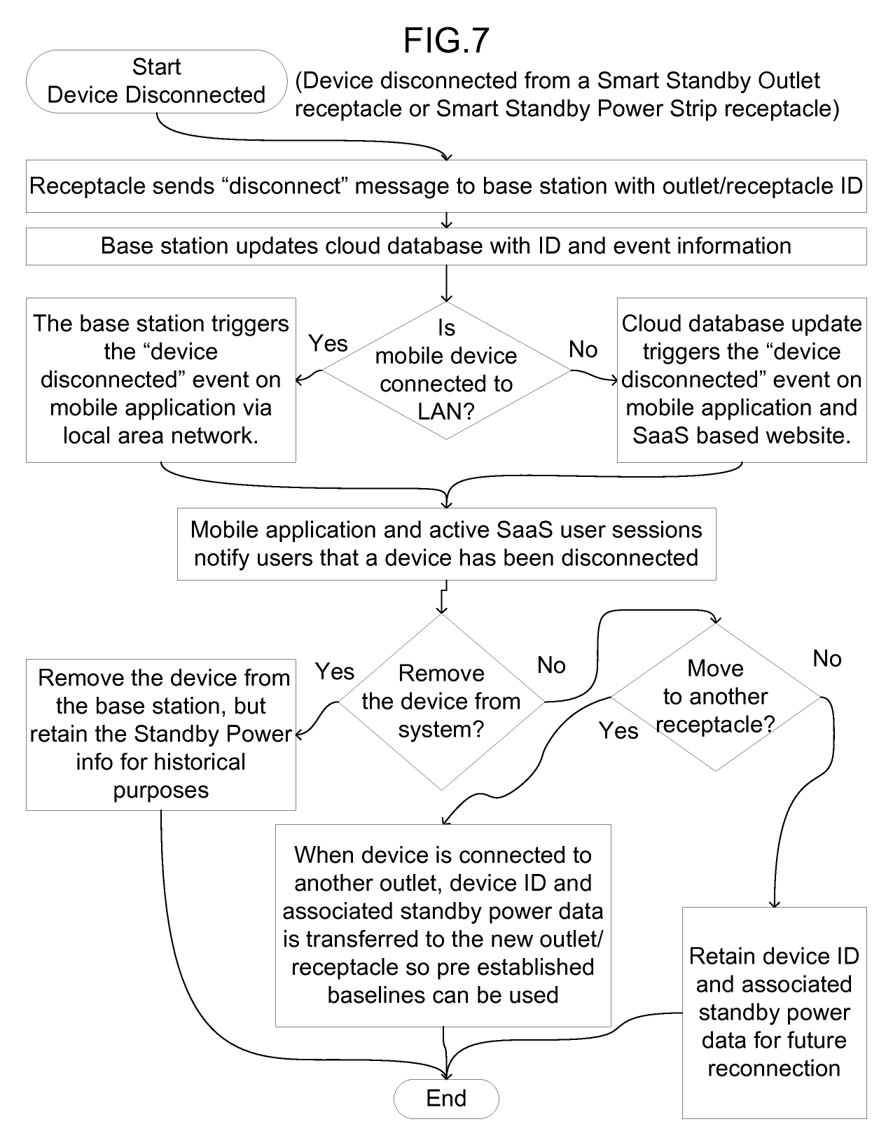

As shown in FIG. 1, the base station will then check if any devices have been disconnected. If any devices have been disconnected they system initializes A/C device disconnection as shown in FIG. 7. When a device is disconnected for a Smart Receptacle, the receptacle sends a “disconnect” message to the base station with the outlet/power strip/receptacle identification information. The base station then updates the cloud database with the identification and event information. A “device disconnected” message is then sent to the mobile device 16 as well as the internet-based SaaS application. The user will then be prompted whether to remove the device from the system or not. If the device is removed from the system the device is removed from the base station but the standby power information will be retained for historical purposes. If the device is not removed from the system the user will be asked if the device is being moved to a different receptacle. If the device is being moved the baseline information will be reassigned to the new receptacle and will continue to operate normally. If the device is not being moved, the baseline information will be stored until the device is reconnected to the system.

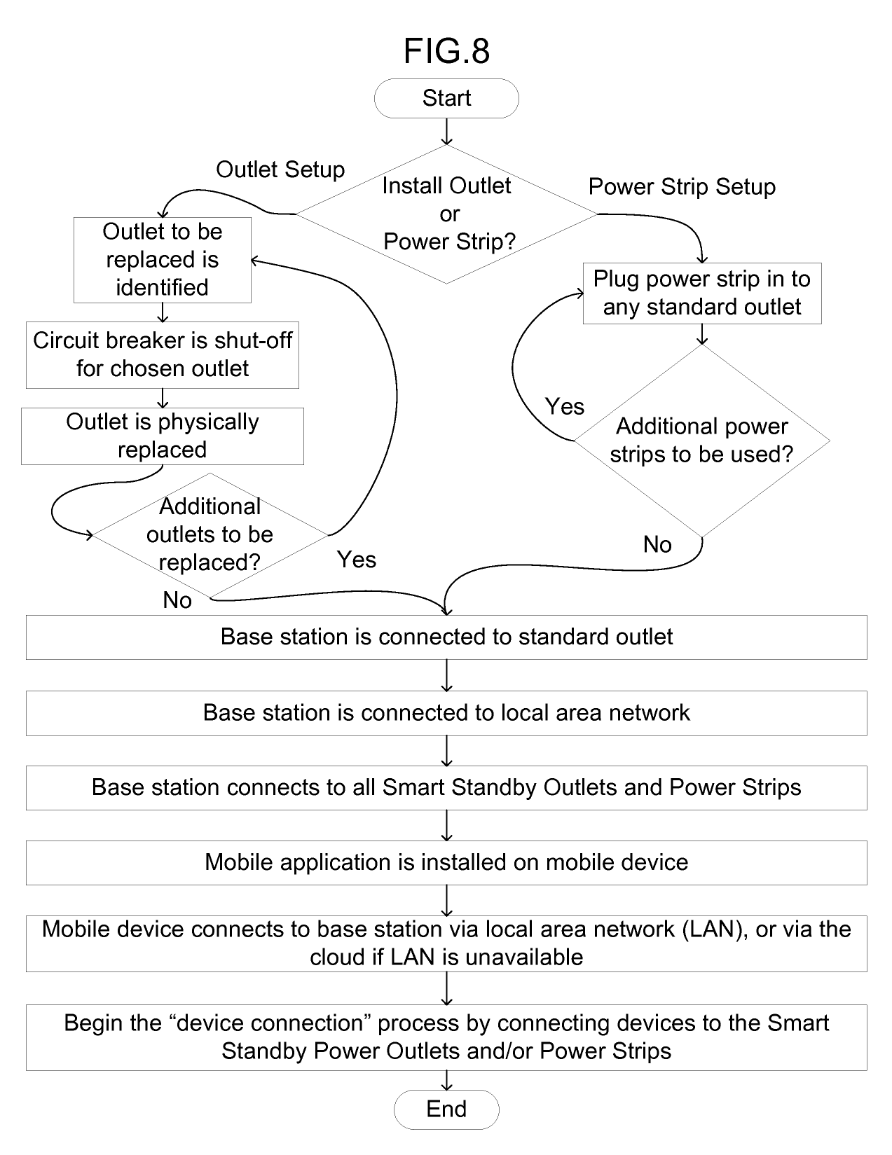

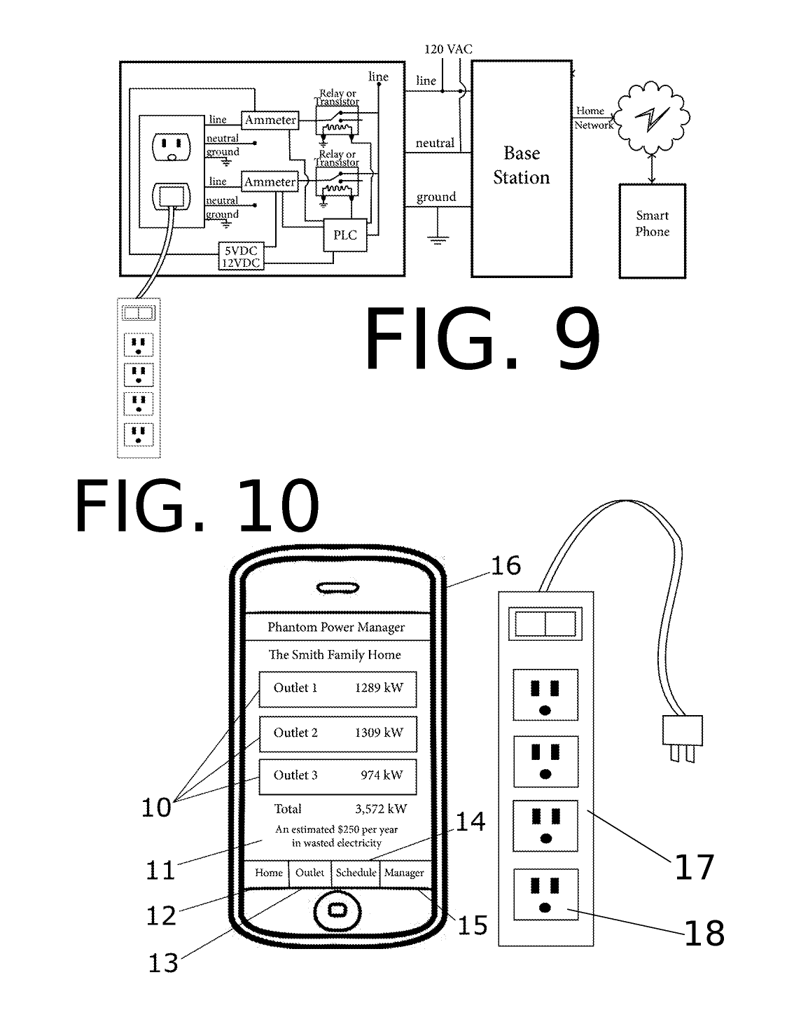

As shown in FIG. 8 the system is installed by first installing Smart Standby Power Outlets or Smart Standby Power Strips. For power outlets, the outlet to be replaced is identified, the circuit breaker is shut off for the chosen outlet, and the outlet is physically replaced. This is repeated for every outlet to be replaced. For power strips, the power strip is simply plugged into any standard existing power outlet. The Smart Standby Base Station is plugged into a standard power outlet and connected to the local area network. The base station will then connect to all Smart Standby Power Outlets and Smart Standby Power Strips. The user installs the mobile application on a mobile device 16. The mobile device 16 is then connected to the base station through the local area network or via the cloud if LAN is unavailable.

Electronic components of the base station include a USB port, an Ethernet port, a memory device, and a microprocessor. The power outlets, power strips, and the base station are preferably manufactured from rigid, durable materials, such as steel, plastic, acrylic polymer, aluminum alloy, and copper alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

We claim:

1. An energy management system and method of operation, the system comprising:
(a) a receptacle node;
(b) a base station;
(c) said base station and said receptacle node being in electronic communication with one another;
(d) a user interface;
(e) said user interface and said base station being in electronic communication with one another;
(f) said receptacle node comprising one or more receptacles;
(g) for each of said one or more receptacles, an ammeter, said ammeter being configured so as to measure electrical current through said one or more receptacles;
(h) the output of said ammeter being electronically available to said receptacle node and, via said receptacle node, to said base station;
(i) said receptacle node being configured for detecting whether any device is connected to each of said one or more receptacles;
(j) said receptacle node being configured for distinguishing between a full load power consumption level and a standby power consumption level in each of said one or more receptacles; and
(k) a database;
and the method comprising:
(l) monitoring each of said one or more receptacles for any device connection;
(m) for each of said one or more receptacles having any new device connection, creating an identity in said database;
(n) for each identity in said database, establishing a baseline full load power consumption level and storing said baseline full load power consumption level to said identity;
(o) for each identity in said database, establishing a baseline standby power consumption level and storing said baseline standby power consumption level to said identity; and;
(p) making both said baseline full load power consumption level and said standby power consumption level accessible via said user interface.

2. The energy management system and method of claim 1 wherein said receptacle node and said base station communicate via power line communication.

3. The energy management system and method of claim 1 wherein said user interface is a mobile app.

4. The energy management system and method of claim 2 wherein said user interface is a mobile app.

5. The energy management system and method of claim 1, the method further comprising, for each of said one or more receptacles:
(a) estimating an annual standby power loss;
(b) storing said annual standby power loss to said identity;
(c) generating a recommendation to shutdown that of said one or more receptacles; and
(d) transmitting said recommendation via said user interface.

6. The energy management system and method of claim 5 wherein said receptacle node and said base station communicate via power line communication.

7. The energy management system and method of claim 5 wherein said user interface is a mobile app.

8. The energy management system and method of claim 6 wherein said user interface is a mobile app.

9. The energy management system and method of claim 5, the system further comprising:
(a) for each of said one or more receptacles, a relay;
(b) said relay being electronically controlled; and
(c) said relay being configured for selectively enabling and disabling power to that of said one or more receptacles with which said relay is associated;
and the method further comprising:
(d) for each of said recommendation generated, checking user approval and, if approved, shutting down that of said one or more receptacles to which said recommendation pertains in response to detection of the standby power level.

10. The energy management system and method of claim 9 wherein said receptacle node and said base station communicate via power line communication.

11. The energy management system and method of claim 9 wherein said user interface is a mobile app.

12. The energy management system and method of claim 10 wherein said user interface is a mobile app.

13. The energy management system and method of claim 5, the method further comprising defining a schedule; said schedule comprising times of enabling or disabling any of said one or more receptacles; and enabling or disabling said one or more receptacles in response to said schedule.

14. The energy management system and method of claim 13 wherein said receptacle node and said base station communicate via power line communication.

15. The energy management system and method of claim 13 wherein said user interface is a mobile app.

16. The energy management system and method of claim 14 wherein said user interface is a mobile app.

17. The energy management system and method of claim 9, the method further comprising defining a schedule; said schedule comprising times of enabling or disabling any of said one or more receptacles; and enabling or disabling said one or more receptacles in response to said schedule.

18. The energy management system and method of claim 17 wherein said receptacle node and said base station communicate via power line communication.

19. The energy management system and method of claim 17 wherein said user interface is a mobile app.

20. The energy management system and method of claim 18 wherein said user interface is a mobile app.
